(19) United States
(12) Patent Application Publication
(10) Pub. No.: US 2021/0226276 A1
(43) Pub. Date: Jul. 22, 2021

(54) CONTROL OF COOLANT TEMPERATURE IN ENERGY STORAGE ENCLOSURE

(71) Applicant: GM GLOBAL TECHNOLOGY OPERATIONS LLC, Detroit, MI (US)

(72) Inventors: Kris Sevel, Rochester Hills, MI (US); Orlando Ward-Santos, Berkley, MI (US); Kyle Holihan, South Lyon, MI (US); Andrew M. Zettel, Port Moody (CA)

(73) Assignee: GM GLOBAL TECHNOLOGY OPERATIONS LLC, Detroit, MI (US)

(21) Appl. No.: 16/747,277

(22) Filed: Jan. 20, 2020

(51) Int. Cl. H01M 10/633; H01M 10/625; B60L 58/26; B60L 53/60; H01M 10/613; H01M 10/48; H01M 10/44

(52) U.S. Cl. CPC H01M 10/633; H01M 10/625; B60L 58/26; B60L 53/60; B60L 2240/545; H01M 10/486; H01M 10/44; H01M 2220/20; H01M 10/613

(57) ABSTRACT

A method of controlling temperature of a coolant supplied to a battery pack includes detecting a request for charging the battery pack, and commanding, via the electronic controller, a rate of charge of the battery pack. The method also includes determining the dew point inside the battery pack during the charging. The method additionally includes commanding a supply of coolant to the battery pack while the battery pack is charging. The method also includes regulating a temperature of the coolant to maintain the battery pack above the determined dew point during the charging. The method may further include maximizing the rate of charge at the regulated temperature of the coolant. A battery system employing an electronic controller configured to perform such a method, and a motor vehicle using such a battery system are also within the scope of the present disclosure.

### INTRODUCTION

The present disclosure relates to a system and a method for controlling temperature of a coolant in an energy storage enclosure.

An electrical energy storage or battery system may include a plurality of battery cells in relatively close proximity to one another and retained in an enclosure. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Unless accompanied by effective cooling, such chemical reactions may cause more heat to be generated by the batteries than is effectively withdrawn, thereby causing battery damage. In battery arrays, liquid cooling is frequently employed to reduce the spread of thermal energy from a cell experiencing elevated temperature to adjacent cells.

### SUMMARY

A method of controlling temperature of a coolant supplied to a battery pack during charging includes detecting, via an electronic controller, a request for charging the battery pack. The method also includes commanding, via the electronic controller, a rate of charge of the battery pack. The method additionally includes determining, via the electronic controller, the dew point inside the battery pack during the charging. The method also includes commanding, via the electronic controller, a supply of coolant to the battery pack while the battery pack is charging. The method additionally includes regulating, via the electronic controller, a temperature of the coolant to maintain the battery pack above the determined dew point during the charging. The method may further include maximizing, via the electronic controller, the rate of charge at the regulated temperature of the coolant.

Determining the dew point may include detecting a characteristic indicative of a temperature inside the battery pack via a first sensor in communication with the electronic controller. Additionally, determining the dew point may include detecting a characteristic indicative of the humidity inside the battery pack via a second sensor in communication with the electronic controller. Furthermore, determining the dew point may include using the respective characteristics detected by the first and second sensors in a look-up table.

The battery pack may include a battery pack housing. Each of the first and second sensors may be arranged inside the battery pack housing.

The method may also include setting, via the electronic controller, the temperature of the coolant above a first threshold temperature selected to minimize lithium plating inside the battery pack. The first threshold temperature is a minimum temperature to support a maximized rate of charge that will prevent or minimize formation of lithium plating inside the battery pack.

The method may also include setting, via the electronic controller, the temperature of the coolant above a second threshold temperature selected to minimize condensation inside the battery pack. In other words, the second threshold temperature is a minimum temperature to support a maximized rate of charge that will prevent or minimize condensation inside the battery pack.

Setting the temperature of the coolant may include heating the coolant to above the detected temperature inside the battery pack to maintain the battery pack above the determined dew point during the charging.

The battery pack may be arranged inside a motor vehicle having a vehicle cabin. The battery pack may be arranged inside the motor vehicle. The characteristic indicative of temperature inside the battery pack may be temperature inside the vehicle cabin and the characteristic indicative of humidity inside the battery pack may be humidity inside the vehicle cabin. The first sensor may be configured to detect the temperature directly inside the vehicle cabin, while the second sensor may be configured to detect the humidity directly inside the vehicle cabin. In such an embodiment, determining the dew point may include rationalizing, via the electronic controller, the dew point inside the battery pack during the charging in response to the detected temperature inside the vehicle cabin and the detected humidity inside the vehicle cabin.

A battery system employing an electronic controller to perform the above-disclosed method of controlling temperature of coolant, and a motor vehicle using such a battery system are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing a hybrid powertrain with multiple power-sources, and a battery system including a battery pack configured to generate and store electrical energy for supplying the electrical energy to the power-sources, according to the disclosure.

FIG. 2 is a schematic top perspective exploded view of a battery module shown in FIG. 1, having the battery pack and a cooling plate configured to regulate temperature of the battery pack via a supply of coolant, according to the disclosure.

FIG. 3 illustrates a method of controlling temperature of coolant supplied to the battery pack shown in FIGS. 1-2 during charging.

### DETAILED DESCRIPTION

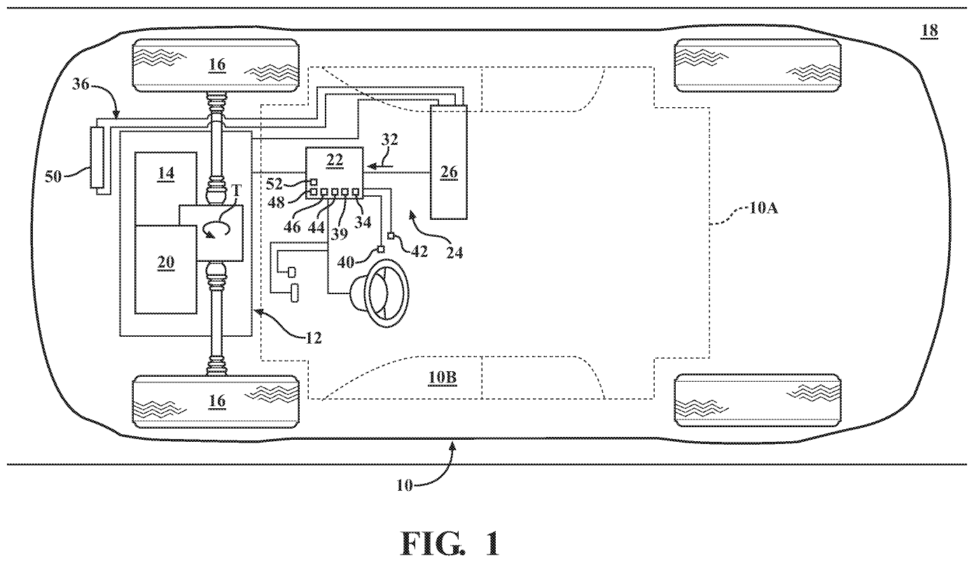

Referring to FIG. 1, a motor vehicle 10 having a powertrain 12 is depicted. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator. As shown in FIG. 1, the powertrain 12 may also include an additional power-source 20, such as an internal combustion engine. The power-sources 14 and 20 may act in concert to power the vehicle 10.

The vehicle 10 additionally includes a programmable electronic controller 22 and a battery system 24 configured to generate and store electrical energy through heat-producing electro-chemical reactions for supplying the electrical energy to the power-sources 14 and 20. The electronic controller 22 may be programmed to control the powertrain 12 and the battery system 24 to generate a predetermined amount of power-source torque T, and various other vehicle systems. The electronic controller 22 may include a central processing unit (CPU) that regulates various functions on the vehicle 10, or be configured as a powertrain control module (PCM) configured to control the powertrain 12. In either of the above configurations, the electronic controller 22 includes a processor and tangible, non-transitory memory, which includes instructions for operation of the powertrain 12 and the battery system 24 programmed therein. The memory may be an appropriate recordable medium that participates in providing computer-readable data or process instructions. Such a recordable medium may take many forms, including but not limited to non-volatile media and volatile media.

Non-volatile media for the electronic controller 22 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer, or via a wireless connection. Memory of the electronic controller 22 may also include a flexible disk, hard disk, magnetic tape, another magnetic medium, a CD-ROM, DVD, another optical medium, etc. The electronic controller 22 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry. Algorithms required by the electronic controller 22 or accessible thereby may be stored in the memory and automatically executed to provide the required functionality of the powertrain 12 and the battery system 24.

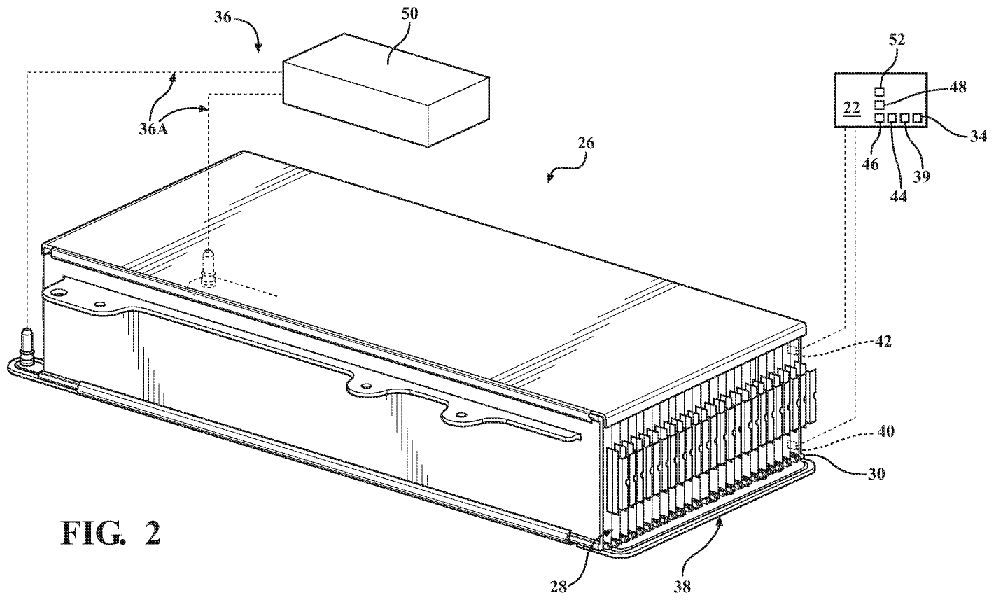

The battery system 24 maybe connected to the power-sources 14 and 20, the electronic controller 22, as well as other vehicle systems via a high-voltage BUS (not shown). As shown in FIG. 2, the battery system 24 includes a battery module 26 having one or more rechargeable energy storage cells forming a battery pack 28. The battery pack 28 is configured to supply an electric current to power the electric motor-generator 14. The energy storage cell(s) in the battery pack 28 may be Lithium-ion type. In most lithium-ion batteries, a positive electrode is a metal oxide, the negative electrode is carbon and the electrolyte is a Lithium salt in an organic solvent. As shown, the battery pack 28 may include a battery pack enclosure or housing 30.

Operatively, the electronic controller 22 is part of the battery system 24, and is specifically configured, i.e., programmed, to detect a request 32 for charging the battery pack 28. The request 32 for charging the battery pack 28 may be the result of detection of the battery pack state of charge (SOC) having dropped below a predetermined SOC. The electronic controller 22 would then command a specific rate of charge 34 of the battery pack 28 by setting a value of charge current flowing into the battery pack in response to the detected request 32. In general, the rate of charging a Lithium-ion battery pack 28 is ambient temperature dependent, for example, fast charging may be commanded in the range of 5 to 45° C., and for optimum results, may be done in the range of 10 to 30° C.

Generally, the service life of lithium-ion batteries depends on the cell material, operating conditions, and environmental conditions. In vehicle applications, battery systems are typically exposed to fluctuating environmental conditions. To ensure the safe operation of the battery system 24, and to prolong its lifespan, the battery system is equipped with a cooling system 36. The cooling system 36 may be a liquid or an evaporative cooling system, for example circulating a coolant 38A through a cooling plate 38 arranged as part of the battery module 26, as shown in FIG. 2. The use of the cooling system 36 may, however, cause condensation of water in the battery pack housing 30. Condensation occurs if, for example, the temperature of the cooling plate 38 drops below the dew point. Condensation inside the battery system 24 may damage system components, cause corrosion, reduce the battery system's insulation resistance, and accelerate aging of the battery cells. These effects may shorten the life of the battery system 30, especially of the system's electrical devices and metallic parts.

Lithium-ion batteries are also susceptible to lithium plating, also called deposition, inside the battery cells. Generally, lithium plating is the formation of metallic lithium around the anode of Lithium-ion batteries during charging. Lithium plating may cause these batteries to malfunction over time. Under normal charging conditions in a Lithium-ion battery, such as the battery pack 28, lithium ions (Li+) shuttle from the cathode to the anode and intercalate, i.e., become inserted or interposed, quickly into the layered active material (typically graphite) of the anode, which does not induce anode lithium plating. Lithium plating takes place during the intercalation, because lithium plating is kinetically favorable, as the working potential of graphite is very close to that of metallic lithium deposition.

The main reasons for lithium plating are 1) high battery charging rate and overcharging, i.e., high charging current forcing the lithium ions to move at a faster reaction rate and accumulate on the surface of the anode, 2) low charging temperature, which causes the reaction rate to slow down, thus affecting the intercalation of lithium ions, and 3) physical aspects of the battery design, such as low anode/cathode ratio and manufacturing defects. Generally, thus deposited lithium metal easily reacts with the electrolyte, which, on the one hand, consumes active lithium and electrolyte, and on the other hand, causes the loss of electrical contact of some deposited lithium with the anode (referred to as dead lithium), thus accelerating capacity fading. Additionally, the reaction between lithium metal and electrolyte forms a redundant interfacial film, which increases the anode polarization and, in turn, promotes further anode lithium plating. Moreover, the continuous growth of dendritic lithium may pierce the battery separator and induce an internal short circuit, which may result in thermal runway in the battery.

The electronic controller 22 is specifically programmed to control the cooling of battery pack 28 to ensure optimized charging, while controlling condensation of water in the battery pack housing 30 and minimizing lithium plating around the battery anode. To that end, the electronic controller 22 is additionally configured to determine a dew point 39 inside the battery pack 28 during the charging. The electronic controller 22 is also configured to command a supply of coolant 38A to the battery pack 28 while the battery pack is charging. The electronic controller 22 is additionally configured to regulate a temperature of the coolant 38A to maintain the battery pack 28 above the determined dew point 39 to minimize condensation inside the battery pack during the charging. The electronic controller 22 may be further configured to maximize the rate of charge 34, such as via controlling the value of the charge current being supplied to the battery pack 28, at the regulated temperature of the coolant 38A.

The battery system 24 may additionally include a first sensor 40 in communication with the electronic controller 22. The first sensor 40 is configured to detect a characteristic indicative of temperature inside the battery pack 28. The battery system 24 may further include a second sensor 42 in communication with the electronic controller 22. The second sensor 42 is configured to detect a characteristic indicative of humidity inside the battery pack. In such an embodiment, the controller 22 may be programmed with a mathematical relationship 43 for determining the psychrometric ratio, i.e., the ratio of the heat transfer coefficient to the product of mass transfer coefficient and humid heat at a wetted surface, which appears as follows:

$$r = \frac{{h}_{c}}{{k}_{y} {c}_{s}} \qquad ( 43 )$$

Wherein “r” represents a psychrometric ratio (dimensionless); “h_{c}” represents a convective heat transfer coefficient (in W m⁻² K⁻¹); “k_{y}” represents convective mass transfer coefficient (in kg m⁻² s⁻¹); and “cₛ” represents humid heat (in J kg⁻¹ K⁻¹). Generally, the psychrometric ratio relates absolute humidity and saturation humidity to the difference between the dry bulb temperature and the adiabatic saturation temperature.

The mathematical relationship 43 may be used to determine the dew point 39 using the respective characteristics detected by the first and second sensors 40, 42. Alternatively, the mathematical relationship 43 may be used to evaluate experimental data and generate a look-up table 44 based on a psychrometric chart. Generally, a psychrometric chart is a graph of the thermodynamic parameters of moist air at a constant pressure, often equated to an elevation relative to sea level. The resulting look up table 44 may then be programmed into the controller 22 for determining the dew point 39 based on the characteristics detected by the first and second sensors 40, 42. In a particular embodiment shown in FIG. 2, each of the first sensor 40 and the second sensor 42 may be arranged inside the battery pack housing 30. Accordingly, in such an embodiment the characteristic indicative of temperature inside the battery pack 28 may be temperature actually measured inside the battery pack housing 30. Similarly, the characteristic indicative of humidity inside the battery pack 28 may be humidity actually measured inside the battery pack housing 30

The electronic controller 22 may also be configured to set the temperature of the coolant 38A above a first threshold temperature 46. The first threshold temperature 46 may be selected to minimize lithium plating inside the battery pack 28. Specifically, the first threshold temperature 46 is a low temperature limit configured to maximize the rate of charge 34 along with limiting formation of lithium plating inside the battery pack 28. The electronic controller 22 may additionally be configured to set the temperature of the coolant 38A above a second threshold temperature 48. The second threshold temperature 48 may be selected to minimize condensation inside the battery pack 28. Specifically, the second threshold temperature 48 is a low temperature limit configured to maximize the rate of charge 34 along with limiting condensation inside the battery pack 28.

The electronic controller 22 may be specifically programmed to set the temperature of the coolant 38A above the higher of the first threshold temperature 46 and the second threshold temperature 48 to minimize both the lithium plating and the condensation inside the battery pack 28, while maximizing the rate of charge 34. The electronic controller 22 may be additionally configured to command heating of the coolant 38A to set the coolant temperature. Specifically, the coolant 38A may be passed or circulated through a heat exchanger 50 (shown in FIG. 1) and thereby heated to raise or maintain the temperature inside the battery pack 28 to keep the environment inside battery pack housing 30 above the determined dew point 39 during the charging.

With resumed reference to FIG. 1, the motor vehicle 10 may have a vehicle cabin 10A. The vehicle cabin 10A is equipped with a variable position panel 10B, such as a glass window, configured to control size of an opening between the vehicle cabin and an ambient environment. Therefore, with uncovering of the opening via the variable position panel 10B, the ambient air is permitted to enter the cabin 10A. In such an embodiment, the characteristic indicative of temperature inside the battery pack 28 may be temperature inside the vehicle cabin 10A, and the characteristic indicative of humidity inside the battery pack may be humidity inside the vehicle cabin (and generally the humidity of the ambient environment).

Furthermore, the first sensor 40 may be arranged inside the vehicle cabin 10A and configured to directly detect the temperature therein. The second sensor 42 may be similarly arranged inside the vehicle cabin 10A and configured to directly detect the humidity therein. The electronic controller 22 may be additionally configured to rationalize the dew point 39 inside the battery pack 28 in response to the detected temperature and the detected humidity inside the vehicle cabin 10A (a position of the panel 10B). A correlation between the dew point inside the battery pack 28 and the detected temperature and humidity inside the vehicle cabin 10A may be empirically developed and programmed into the electronic controller 22, for example as a look-up table 52 to be accessed during charging of the battery pack 28.

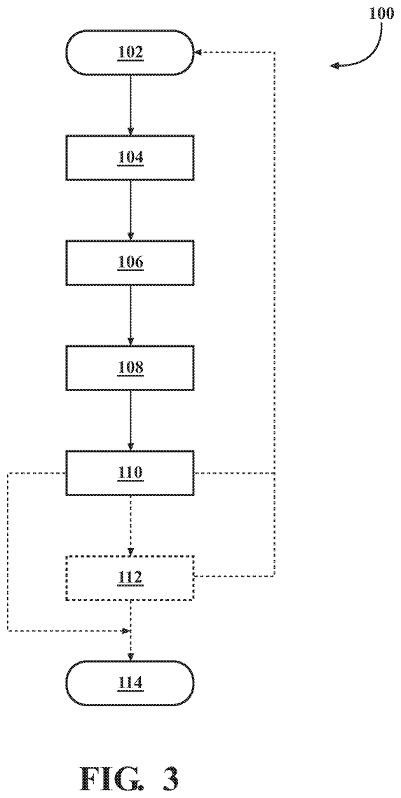

A method 100 of controlling the dew point 39 in the battery pack 28 during charging is shown in FIG. 3 and described below with reference to the structure shown in FIGS. 1-2. Method 100 commences in frame 102 with detecting, via the electronic controller 22, a request for charging the battery pack 28. Following frame 102, the method advances to frame 104. In frame 104, the method includes commanding, via the electronic controller 22, the rate of charge 34 of the battery pack 28. From frame 104, the method moves on to frame 106, where the method includes determining, via the electronic controller 22, the dew point 39 inside the battery pack 28 during the charging.

As described with respect to FIGS. 1-2, the first sensor 40 may detect a characteristic indicative of temperature inside the battery pack 28 by specifically measuring temperature inside the battery pack housing 30. Similarly, the second sensor 42 may detect a characteristic indicative of humidity inside the battery pack 28 by specifically measuring humidity inside the battery pack housing 30. In a separate embodiment, as additionally described with respect to FIGS. 1-2, the characteristic indicative of temperature inside the battery pack 28 may be the temperature inside the vehicle cabin 10A, while the characteristic indicative of humidity inside the battery pack 28 may be humidity inside the vehicle cabin.

In the above embodiment, the first sensor 40 may be arranged inside the vehicle cabin 10A and configured to detect the temperature directly therein. Similarly, the second sensor 42 may be arranged inside the vehicle cabin 10A and be configured to detect the humidity directly therein. Accordingly, determining the dew point 39 may include rationalizing, the dew point 39 inside the battery pack during the charging in response to the detected temperature inside the vehicle cabin 10A and the detected humidity inside the vehicle cabin. According to the method, the controller 22 may be programmed with the mathematical relationship 43 and/or the look-up table 52, and use the respective characteristics detected by the first and second sensors 40, 42 to determine the dew point inside the battery pack 28.

Following frame 106, the method may proceed to frame 108. In frame 108 the method includes commanding, via the electronic controller 22, the supply of coolant 38A to the battery pack 28 while the battery pack is charging. After frame 108 the method proceeds to frame 110. In frame 110 the method includes regulating, via the electronic controller 22, the temperature of the coolant 38A to maintain the battery pack 28 above the determined dew point 39. As described with respect to FIGS. 1-2 above, thus maintaining the battery pack 28 above the determined dew point 39 is specifically intended to minimize condensation and lithium plating inside the battery pack during the charging. In frame 110 the method may also include setting the temperature of the coolant 38A above the first threshold temperature 46 selected to minimize lithium plating inside the battery pack 28. Additionally, in frame 110 the method may include setting the temperature of coolant 38A above the second threshold temperature 48 selected to minimize condensation inside the battery pack 28. Setting the temperature of the coolant 38A may specifically include heating the coolant 38A to above the determined temperature inside the battery pack 28.

Following frame 110, the method may advance to frame 112. In frame 112 the method includes maximizing, via the electronic controller 22, the rate of charge 34 at the regulated temperature of the coolant 38A. Following either frame 110 or 112, the method may loop back to frame 102 for another control cycle of detecting a request for charging the battery pack 28 and cooling the battery pack, while minimizing condensation and lithium plating inside the battery pack during the subject charging. Alternatively, either following frame 110 or 112, the method may conclude in frame 114.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of controlling temperature of a coolant supplied to a battery pack, the method comprising:
detecting, via an electronic controller, a request for charging the battery pack;
commanding, via the electronic controller, a rate of charge of the battery pack;
determining, via the electronic controller, a dew point inside the battery pack during the charging;
commanding, via the electronic controller, a supply of coolant to the battery pack while the battery pack is charging; and
regulating, via the electronic controller, a temperature of the coolant to maintain the battery pack above the determined dew point during the charging.

2. The method of claim 1, wherein determining the dew point includes:
detecting, via a first sensor in communication with the electronic controller, a characteristic indicative of temperature inside the battery pack;
detecting, via a second sensor in communication with the electronic controller, a characteristic indicative of humidity inside the battery pack; and
using the respective characteristics detected by the first and second sensors in a look-up table to determine the dew point inside the battery pack.

3. The method of claim 2, wherein the battery pack includes a battery pack housing, and wherein the first and second sensors are arranged inside the battery pack housing.

4. The method of claim 2, further comprising setting, via the electronic controller, the temperature of the coolant above a first threshold temperature selected to minimize lithium plating inside the battery pack.

5. The method of claim 2, further comprising setting, via the electronic controller, the temperature of the coolant above a second threshold temperature selected to minimize condensation inside the battery pack.

6. The method of claim 2, wherein setting the temperature of the coolant includes heating the coolant to maintain the battery pack above the determined dew point during the charging.

7. The method of claim 2, wherein:
the battery pack is arranged inside a motor vehicle having a vehicle cabin;
the characteristic indicative of temperature inside the battery pack is temperature inside the vehicle cabin and the characteristic indicative of humidity inside the battery pack is humidity inside the vehicle cabin;
the first sensor is configured to detect the temperature directly inside the vehicle cabin, and the second sensor is configured to detect the humidity directly inside the vehicle cabin; and
determining the dew point includes rationalizing, via the electronic controller, the dew point inside the battery pack during the charging in response to the detected temperature inside the vehicle cabin and the detected humidity inside the vehicle cabin.

8. A battery system comprising:
a battery pack; and
an electronic controller configured to:
detect a request for charging the battery pack;
command a rate of charge of the battery pack;
determine a dew point inside the battery pack during the charging;
command a supply of coolant to the battery pack while the battery pack is charging; and
regulate a temperature of the coolant to maintain the battery pack above the determined dew point during the charging.

9. The system of claim 8, further comprising:
a first sensor configured to detect a characteristic indicative of temperature inside the battery pack; and
a second sensor configured to detect a characteristic indicative of humidity inside the battery pack;
wherein the controller is configured to use the respective characteristics detected by the first and second sensors in a look-up table to determine the dew point inside the battery pack.

10. The system of claim 9, wherein the battery pack includes a battery pack housing, and wherein the first and second sensors are arranged inside the battery pack housing.

11. The system of claim 9, wherein the electronic controller is additionally configured to set the temperature of the coolant above a first threshold temperature selected to minimize lithium plating inside the battery pack.

12. The system of claim 9, wherein the electronic controller is additionally configured to set the temperature of the coolant above a second threshold temperature selected to minimize condensation inside the battery pack.

13. The system of claim 9, wherein the electronic controller is additionally configured to set the temperature of the coolant by commanding heating of the coolant to maintain the battery pack above the determined dew point during the charging.

14. The system of claim 9, wherein:
the battery pack is arranged inside a motor vehicle having a vehicle cabin;
the characteristic indicative of temperature inside the battery pack is temperature inside the vehicle cabin and the characteristic indicative of humidity inside the battery pack is humidity inside the vehicle cabin;
the first sensor is configured to detect the humidity directly inside the vehicle cabin; and
the electronic controller is additionally configured to determine the dew point by rationalizing the dew point inside the battery pack during the charging in response to the detected temperature inside the vehicle cabin and the detected humidity inside the vehicle cabin.

15. A motor vehicle comprising:
an electric motor-generator;
a battery pack configured to supply an electric current to the electric motor-generator; and
an electronic controller configured to:
detect a request for charging the battery pack;
command a rate of charge of the battery pack;
determine a dew point inside the battery pack during the charging;
command a supply of coolant to the battery pack while the battery pack is charging; and
regulate a temperature of the coolant to maintain the battery pack above the determined dew point during the charging.

16. The motor vehicle of claim 15, further comprising:
a first sensor configured to detect a characteristic indicative of temperature inside the battery pack; and
a second sensor configured to detect a characteristic indicative of humidity inside the battery pack;
wherein the controller is configured to use the respective characteristics detected by the first and second sensors in a look-up table to determine the dew point inside the battery pack.

17. The motor vehicle of claim 16, wherein the battery pack includes a battery pack housing, and wherein the first and second sensors are arranged inside the battery pack housing.

18. The motor vehicle of claim 16, wherein the electronic controller is additionally configured to set the temperature of the coolant above the higher of a first threshold temperature selected to minimize lithium plating inside the battery pack and a second threshold temperature selected to minimize condensation inside the battery pack.

19. The motor vehicle of claim 16, wherein the electronic controller is additionally configured to set the temperature of the coolant by commanding heating of the coolant to maintain the battery pack above the determined dew point during the charging.

20. The motor vehicle of claim 16, further comprising a vehicle cabin, wherein:
the characteristic indicative of temperature inside the battery pack is temperature inside the vehicle cabin and the characteristic indicative of humidity inside the battery pack is humidity inside the vehicle cabin;
the first sensor is configured to detect the temperature directly inside the vehicle cabin, and the second sensor is configured to detect the humidity directly inside the vehicle cabin; and
the electronic controller is additionally configured to determine the dew point by rationalizing the dew point inside the battery pack during the charging in response to the detected temperature inside the vehicle cabin and the detected humidity inside the vehicle cabin.
